(19) United States
(12) Patent Application Publication
(10) Pub. No.: US 2026/0333116 A1
(43) Pub. Date: Oct. 22, 2026

(54) MULTI-ORBIT SATELLITE SYSTEM, AND OPERATING METHOD THEREOF

(71) Applicant: AGENCY FOR DEFENSE DEVELOPMENT, Daejeon (KR)

(72) Inventors: Myoung Hun HAN, Daejeon (KR); Bong Soo ROH, Daejeon (KR); Ju Hang SOHN, Daejeon (KR)

(73) Assignee: AGENCY FOR DEFENSE DEVELOPMENT, Daejeon (KR)

(21) Appl. No.: 19/320,222

(22) Filed: Sep. 5, 2025

(30) Foreign Application Priority Data
Apr. 22, 2025 (KR) 10-2025-0052334

(51) Int. Cl. H04W 28/02; H04L 41/122; H04W 84/06

(52) U.S. Cl. CPC H04W 28/0268; H04L 41/122; H04W 28/0263; H04W 84/06

(57) ABSTRACT

A multi-orbit satellite system according to an embodiment of the present invention, including a plurality of satellites operating in different orbits and using a Software-Defined Network (SDN) control technology, includes a first satellite for transmitting a task distribution request message including Quality of Service (QoS) requirement information to an upper node on a network topology defined in the Software-Defined Network, and a second satellite for constituting the upper node of the first satellite in the network topology, receiving the task distribution request message, generating an SDN control signal based on the received task distribution request message and status information of a managed satellite group, and transmitting the generated SDN control signal to the first satellite, wherein the first satellite switches a communication interface of the first satellite based on the SDN control signal.

### CROSS-REFERENCE TO RELATED APPLICATION

This application claims the benefits of Korean Patent Application No. 10-2025-0052334, filed on Apr. 22, 2025, in the Korean Intellectual Property Office, the disclosures of which are incorporated herein in their entireties by reference.

### BACKGROUND

### 1. Field

The present invention relates to a multi-orbit satellite system and an operating method thereof. More specifically, the present invention relates to a multi-orbit satellite system and an operating method thereof, which transmit a task distribution request message to an upper node on a network topology defined in a Software-Defined Network (SDN), and switching a communication interface of a lower node based on an SDN control signal generated at the upper node based on the transmitted task distribution request message and status information of a managed satellite group of the upper node.

### 2. Description of the Related Art

Existing satellite systems are generally operated independently for each satellite's mission. However, satellite systems have significant development and launch costs, limited orbital life, and operational and performance limitations depending on the orbit and operating altitude.

Recently, multi-orbit satellite networks, including Low Earth Orbit (LEO), Medium Earth Orbit (MEO), and Geostationary Earth Orbit (GEO), have been attracting attention. Multi-orbit satellite networks are hierarchically composed of satellites located in different altitude orbits, and each satellite located in each orbit can increase the efficiency and stability of the entire system by performing a unique role.

Low Earth Orbit satellites move quickly and are mainly responsible for high-speed data transmission or communication with user terminals, while Medium Earth Orbit satellites function as an intermediate control node for controlling groups of Low Earth Orbit satellites. Geostationary Earth Orbit satellites are fixed in the same position as the Earth at all times and integrally manage the entire network, performing functions such as resource allocation and traffic load adjustment.

A satellite network configured with a multi-layered structure like this can effectively cover the entire Earth by utilizing the multi-layered structure.

### SUMMARY

According to an aspect of an inventive concept of the disclosure, a multi-orbit satellite system including a plurality of satellites operating in different orbits and using a Software-Defined Network (SDN) control technology, the multi-orbit satellite system may comprise a first satellite for transmitting a task distribution request message including Quality of Service (QoS) requirement information to an upper node on a network topology defined in the Software-Defined Network and a second satellite for constituting the upper node of the first satellite in the network topology, receiving the task distribution request message, generating an SDN control signal based on the received task distribution request message and status information of a managed satellite group, and transmitting the generated SDN control signal to the first satellite, wherein the first satellite switches a communication interface of the first satellite based on the SDN control signal.

According to an embodiment, the first satellite is a Low Earth Orbit (LEO) satellite, and the second satellite may be a Medium Earth Orbit (MEO) satellite or a Geostationary Earth Orbit (GEO) satellite.

According to an embodiment, the Software-Defined Network may be configured to define a data transmission path or a control signal transmission path between the plurality of satellites included in the multi-orbit satellite system.

According to an embodiment, at least a portion of the network topology defined by the Software-Defined Network may be controlled by the second satellite.

According to an embodiment, the QoS requirement information may include information on a required delay tolerance time, reliability, and priority of a task.

According to an embodiment, the information on the priority of the task may include information for identifying a general service or an important service.

According to an embodiment, the first satellite may include a first power source, a first processor, a first switching unit for switching the communication interface, and a first Delay Tolerant Network (DTN) processing unit for storing at least a portion of data transmitted and received for data loss protection.

According to an embodiment, the first satellite may be configured to not directly perform an operation required for generating the SDN control signal, and may be configured to switch the communication interface of the first satellite through the first switching unit based on the SDN control signal received from the second satellite.

According to an embodiment, the first switching unit of the first satellite may be configured to switch the communication interface of the first satellite between a SpaceFibre interface and a SpaceWire interface.

According to an embodiment, the status information of the managed satellite group may include link status, power status, computation resource status, communication interface status, and anomaly status of each of the satellites included in the satellite group managed by the second satellite.

According to an embodiment, the second satellite may include a second power source, a second processor, a second switching unit for switching a communication interface, a second DTN processing unit for storing at least a portion of data transmitted and received for data loss protection, and a routing unit configured to generate the SDN control signal.

According to an embodiment, the routing unit may be configured to reset a network topology of the satellites included in the managed satellite group.

According to an embodiment, the routing unit may be configured to generate the SDN control signal using a Dijkstra algorithm.

According to an embodiment, the first satellite and the second satellite may be connected via an Inter-Satellite Link (ISL).

According to an embodiment, the second satellite may be configured to matrix the multi-orbit satellite system based on the status information of the managed satellite group and the network topology, and may be configured to generate the SDN control signal by applying a Dijkstra algorithm to the matrixed multi-orbit satellite system.

According to an embodiment, the second satellite may be configured to generate the SDN control signal by applying different cost calculation criteria based on whether a corresponding task is an important service or a general service, according to information regarding the priority of the task included in the QoS requirement information.

According to an embodiment, the second satellite may be configured to generate the SDN control signal according to a cost calculation criterion for a maximum improvement of a system performance of the managed satellite group when the corresponding task is the general service, and may be configured to generate the SDN control signal according to a cost calculation criterion for satisfying a required delay tolerance time and a required reliability included in the QoS requirement information when the corresponding task is the important service.

According to an aspect of an inventive concept of the disclosure, a method of operating a multi-orbit satellite system including a plurality of satellites operating in different orbits and using a Software-Defined Network (SDN) control technology, the method may comprise transmitting, by a first satellite, a task distribution request message including Quality of Service (QoS) requirement information to an upper node on a network topology defined in the Software-Defined Network, generating, by the second satellite, an SDN control signal based on the task distribution request message and status information of a managed satellite group, and transmitting the generated SDN control signal to the first satellite, and switching, by the first satellite, a communication interface of the first satellite based on the SDN control signal.

The methods and devices according to embodiments of the present invention overcome the limitations of existing satellite systems that operated independently for each operational orbit, and enable efficient network operation through the configuration of Inter-Satellite Links (ISL) between satellites in multiple orbits.

Furthermore, the methods and devices according to embodiments of the present invention enable mission collaboration between satellites, allowing for flexible responses to various mission environments and making it possible to utilize the satellite system in various fields, including defense and civilian sectors.

Additionally, by separating the control area and the transmission area, the methods and devices according to embodiments of the present invention enable complex routing computations to be handled by Medium Earth Orbit (MEO) or Geostationary Earth Orbit (GEO) satellites, while Low Earth Orbit (LEO) satellites are designed with a lightweight structure centered on high-speed hardware switching, thereby effectively reducing the size, weight, power consumption, and cost of the LEO satellite payload.

### BRIEF DESCRIPTION OF THE DRAWINGS

Embodiments of the disclosure will be more clearly understood from the following detailed description taken in conjunction with the accompanying drawings in which:

FIG. 1 is a conceptual diagram of a multi-orbit satellite system according to an embodiment of the present invention.

FIG. 2 is a block diagram of a first satellite shown in FIG. 1 according to an embodiment.

FIG. 3 is a diagram for describing an operating method of the first satellite shown in FIG. 2.

FIG. 4 is a block diagram of a second satellite shown in FIG. 1 according to an embodiment.

FIG. 5 is a diagram for describing an operating method of the second satellite shown in FIG. 4.

FIG. 6 is a flowchart of an operating method of the multi-orbit satellite system according to an embodiment of the present invention.

FIG. 7 is a flowchart showing an example of detailed steps constituting a process of generating an SDN control signal shown in FIG. 6.

### DETAILED DESCRIPTION

The technical idea of the present invention can have various modifications and can have various embodiments. Specific embodiments will be illustrated in the drawings and described in detail. However, it should be understood that this is not intended to limit the technical idea of the present invention to specific embodiments, but rather to include all modifications, equivalents, and substitutes falling within the scope of the technical idea of the present invention.

In describing the technical idea of the present invention, detailed descriptions of related known technologies will be omitted if it is determined that they may unnecessarily obscure the gist of the present invention. Furthermore, numbers (e.g., first, second, etc.) used in the description herein are merely identification symbols for distinguishing one component from another.

Also, in this specification, when a certain component is referred to as being "connected" or "coupled" to another component, it should be understood that the certain component may be directly connected or directly coupled to the other component, but unless there is specific contrary mention, it may also be connected or coupled via another intermediate component.

Furthermore, terms such as "unit," "er," "or," and "module" disclosed in this specification refer to a unit that processes at least one function or operation, and this may be implemented by hardware or software such as a processor, a micro processor, a micro controller, a central processing unit (CPU), a graphics processing unit (GPU), an accelerated processor unit (APU), a digital signal processor (DSP), an application specific integrated circuit (ASIC), and a field programmable gate array (FPGA), or a combination of hardware and software. Furthermore, the terms may be implemented in a form coupled to a memory that stores data necessary for processing at least one function or operation.

And it is clarified that the distinction between the components in this specification is merely a distinction based on the main function performed by each component. That is, two or more components described below may be combined into one component, or one component may be divided into two or more components according to more subdivided functions. In addition, it goes without saying that each of the components described below may additionally perform some or all of the functions of other components in addition to its own main function, and some of the main functions for which each of the components is responsible may be exclusively performed by other components.

Hereinafter, embodiments of the inventive concept will be described in detail with reference to the accompanying drawings.

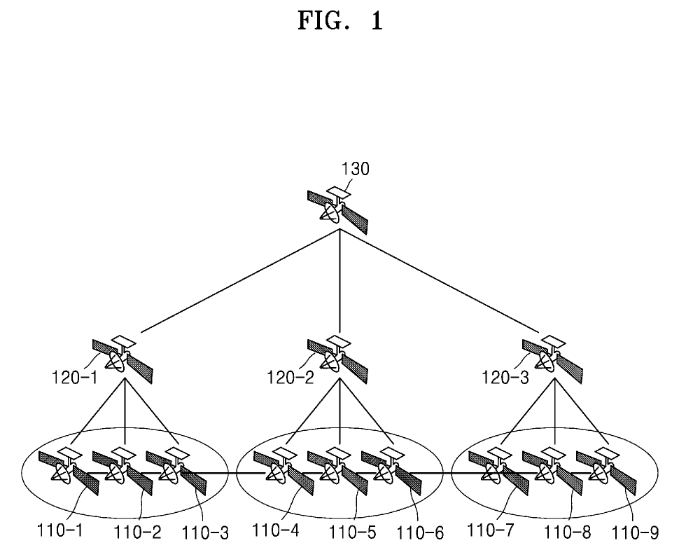

FIG. 1 is a conceptual diagram of a multi-orbit satellite system according to an embodiment of the present invention.

FIG. 1 illustrates a hierarchical structure of a multi-orbit satellite system 10 according to the present invention, which is configured by a plurality of satellites 110-1 to 110-9, 120-1 to 120-3, and 130 located at different orbital altitudes.

Referring to FIG. 1, the multi-orbit satellite system 10 may include a plurality of first satellites 110-1 to 110-9, a plurality of second satellites 120-1 to 120-3, and a third satellite 130.

The first satellites 110-1 to 110-9 are located at a relatively lowest altitude in the multi-orbit satellite system 10, and may be deployed in a relatively largest number within the multi-orbit satellite system 10.

The first satellites 110-1 to 110-9 are configured to collect data and transmit the collected data. For example, the first satellites 110-1 to 110-9 are configured to acquire various ground observation data, or collect or transmit data transmitted from communication devices or other satellites located on the ground.

According to an embodiment, the first satellites 110-1 to 110-9 may be Low Earth Orbit (LEO) satellites.

According to an embodiment, each of the first satellites 110-1 to 110-9 may include a switching device to satisfy high-speed data processing requirements.

According to an embodiment, each of the first satellites 110-1 to 110-9 is configured to perform high-speed communication using a SpaceWire (SpW) interface or a SpaceFibre (SpFi) interface as an interface conforming to space network standards.

According to an embodiment, each of the first satellites 110-1 to 110-9 does not directly generate an SDN control signal for signal processing or control of a signal transmission path on a Software Defined Network (SDN), and is configured to perform a packet switching function or determine a data transmission path based on an SDN control signal generated by a satellite (e.g., 120-1 to 120-3, or 130) constituting an upper node on a network topology defined in the Software Defined Network.

According to an embodiment, the SDN control signal may include various control information such as routing path control, interface switching, traffic priority setting, and transmission schedule control within the multi-orbit satellite system 10.

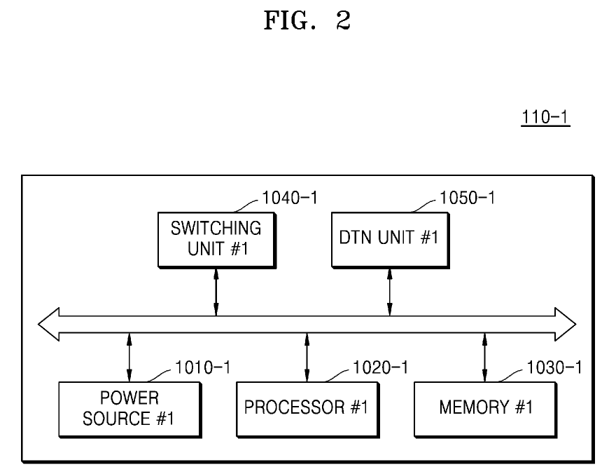

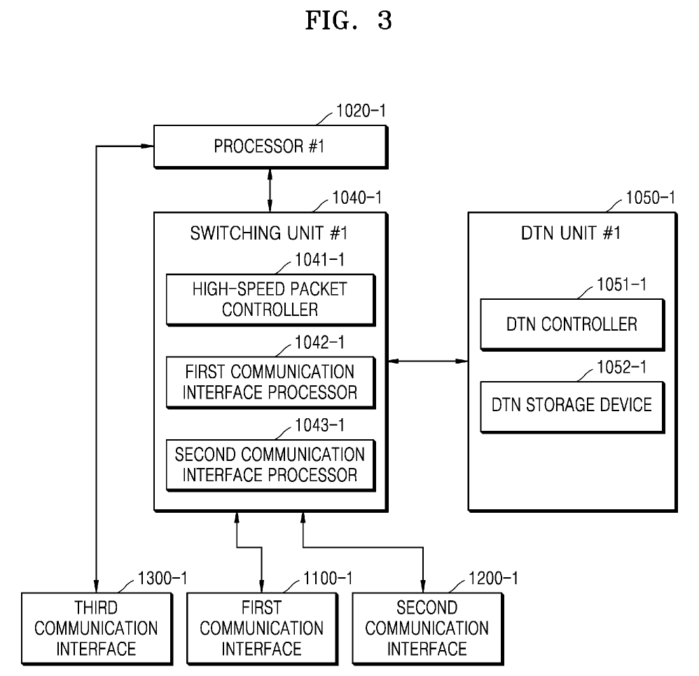

The detailed structure and operation of each of the first satellites 110-1 to 110-9 will be described later with reference to FIGS. 2 and 3.

The second satellites 120-1 to 120-3 are located at a relatively intermediate altitude in the multi-orbit satellite system 10, and may be deployed in a smaller number compared to the first satellites 110-1 to 110-9.

According to an embodiment, the second satellites 120-1 to 120-3 are configured to perform a control function for satellites included in a managed satellite group.

According to an embodiment, the managed satellite group managed by each of the second satellites 120-1 to 120-3 may be defined by the Software Defined Network. For example, some of the first satellites 110-1 to 110-3 may be defined as a managed satellite group of a specific second satellite (e.g., 120-1).

The second satellites 120-1 to 120-3 are configured to collect status information for a managed satellite group, and based on the collected status information, perform transmission path control of data or control signals, or generate an SDN control signal for controlling at least a portion of the network topology defined by the Software Defined Network.

According to an embodiment, the second satellites 120-1 to 120-3 may be Medium Earth Orbit (MEO) satellites.

According to an embodiment, each of the second satellites 120-1 to 120-3 is configured to receive a task distribution request message from a lower node satellite, for example, the first satellites 110-1 to 110-9, and configured to generate an SDN control signal based on the received task distribution request message and status information of the managed satellite group. In this case, each of the second satellites 120-1 to 120-3 is configured to transmit the SDN control signal generated in response to the task distribution request message to the satellites requiring control.

According to an embodiment, the second satellites 120-1 to 120-3 are configured to communicate with the third satellite 130.

The third satellite 130 is located at a relatively highest altitude in the multi-orbit satellite system 10, and may be deployed in a relatively smallest number.

According to an embodiment, the third satellite 130 is configured to perform a global control function.

According to an embodiment, the third satellite 130 is configured to perform resource allocation, path optimization, and collaboration adjustment for the entire network of the multi-orbit satellite system 10.

According to an embodiment, the third satellite 130 is configured to receive and analyze network status information transmitted from the second satellites 120-1 to 120-3. The third satellite 130 is configured to determine an overload state of each of the second satellites 120-1 to 120-3 according to the analysis result, and to distribute tasks.

According to an embodiment, the third satellite 130 is configured to collect status information of the entire network of the multi-orbit satellite system 10, and based on the collected status information, perform transmission path control of data or control signals, or generate an SDN control signal for controlling at least a portion of the network topology defined by the Software Defined Network.

According to an embodiment, the third satellite 130 may be a Geostationary Earth Orbit (GEO) satellite.

According to an embodiment, the first satellites 110-1 to 110-9 and the second satellites 120-1 to 120-3, and the second satellites 120-1 to 120-3 and the third satellite 130 are connected via an Inter-Satellite Link (ISL) and are configured to perform communication with each other. For example, the Inter-Satellite Link (ISL) may be implemented as a communication link based on low-latency, ultra-high-speed laser communication.

FIG. 2 is a block diagram of a first satellite shown in FIG. 1 according to an embodiment. FIG. 3 is a diagram for describing an operating method of the first satellite shown in FIG. 2.

FIG. 2 exemplarily illustrates a configuration of one first satellite 110-1 among the plurality of first satellites 110-1 to 110-9, but the remaining first satellites 110-2 to 110-9 may also be configured with substantially the same components and configured to perform substantially the same operations.

Referring to FIGS. 1 and 2, the first satellite 110-1 is configured to be responsible for a transmission area within the multi-orbit satellite system 10.

The first satellite 110-1 may include a first power source 1010-1, a first processor 1020-1, a first memory 1030-1, a first switching unit 1040-1, and a first DTN unit 1050-1.

The first power source 1010-1 is configured to stably supply power to each component within the first satellite 110-1.

According to an embodiment, the first power source 1010-1 may further include an energy harvesting device (e.g., a solar cell module) for stably securing energy in a space environment, a battery, and a Power Distribution Unit (PDU).

The first processor 1020-1 is a central processing unit for system control of the first satellite 110-1, and is configured to perform various data processing required in each configuration within the first satellite 110-1.

The first memory 1030-1 is configured to store programs necessary for the operation of the first processor 1020-1, data used in the computation processing of the first processor 1020-1, and data generated according to the computation processing result of the first processor 1020-1.

The first switching unit 1040-1 is configured to control the operation switching of configurations for data processing based on a plurality of communication interfaces.

The first DTN unit (Delay/Disruption Tolerant Networking Unit) 1050-1 is configured to perform stable data communication by temporarily storing and then transmitting data even when a delay occurs in communication of the first satellite 110-1 or communication disconnection is expected.

The first satellite 110-1 is configured to not directly perform an operation required for generating the SDN control signal, and is configured to switch a communication interface of the first satellite 110-1 based on the SDN control signal received from the second satellite (e.g., 120-1). In this case, the switching of the communication interface may be performed through the first switching unit 1040-1.

Referring to FIG. 3, the first satellite 110-1 does not include a configuration for routing processing. In addition, the first processor 1020-1 is illustrated as a configuration distinct from the first switching unit 1040-1, but according to an embodiment, the first processor 1020-1 may be implemented as part of the first switching unit 1040-1.

The first satellite 110-1 may include a plurality of communication interfaces 1100-1, 1200-1, and 1300-1.

The first communication interface 1100-1 and the second communication interface 1200-1 may be different types of communication interfaces constituting an Inter-Satellite Link (ISL).

According to an embodiment, each of the first communication interface 1100-1 and the second communication interface 1200-1 may be a SpaceFibre interface or a SpaceWire interface.

The third communication interface 1300-1 is an interface utilized for internal communication of the first satellite 110-1, and may be utilized for transmitting or receiving data(e.g., Telemetry (TM)) for payload status monitoring, or transmitting or receiving control signals (e.g., Telecommand (TC)) within the first satellite 110-1.

According to an embodiment, the third communication interface 1300-1 may be a Controller Area Network (CAN) interface.

The first processor 1020-1 is configured to transmit and receive data(e.g.,Telemetry (TM)) related to payload status monitoring within the first satellite 110-1 or control signals(e.g., Telecommand (TC)) through the third communication interface 1300-1.

The first satellite (e.g., 110-1) is configured to transmit a task distribution request message including Quality of Service (QoS) requirement information to a second satellite (e.g., 120-1) corresponding to an upper node on a network topology defined in a Software Defined Network (SDN). In this case, the first processor 1020-1 of the first satellite 110-1 is configured to generate the task distribution request message.

According to an embodiment, the first satellite (e.g., 110-1) is configured to transmit the generated task distribution request message to the second satellite (e.g., 120-1) through the first communication interface processor 1042-1 of the first switching unit 1040-1 and the first communication interface 1100-1. According to an embodiment, the first communication interface 1100-1 may be a SpaceWire (SpW) interface.

According to another embodiment, the first satellite (e.g., 110-1) is configured to transmit the generated task distribution request message to the second satellite (e.g., 120-1) through the second communication interface processor 1043-1 of the first switching unit 1040-1 and the second communication interface 1200-1. According to an embodiment, the first communication interface 1100-1 may be a SpaceFibre interface.

According to an embodiment, the Software Defined Network is configured to define a data transmission path or a control signal transmission path between the plurality of satellites 110-1 to 110-9, 120-1 to 120-3, and 130 included in the multi-orbit satellite system 10.

According to an embodiment, the QoS requirement information may include information on a required delay tolerance time, reliability, and priority of a task.

According to an embodiment, the information on the priority of the task may include information for identifying a general service or an important service.

The first satellite (e.g., 110-1) is configured to receive an SDN control signal generated based on the task distribution request message transmitted from the first satellite (e.g., 110-1) from the second satellite (e.g., 120-1) corresponding to an upper node on a network topology defined in the Software Defined Network (SDN). In this case, the SDN control signal transmitted from the second satellite (e.g., 120-1) is configured to be received through the first communication interface 1100-1 and configured to be transmitted to the first processor 1020-1 through the first communication interface processor 1042-1. The first processor 1020-1 is configured to set an internal communication path or a communication interface in the first satellite 110-1 based on the received SDN control signal. The first processor 1020-1 is configured to transmit a control signal for setting the communication interface to the high-speed packet controller 1041-1 of the first switching unit 1040-1, which will be described later.

The first switching unit 1040-1 may include a high-speed packet controller 1041-1, a first communication interface processor 1042-1, and a second communication interface processor 1043-1.

The high-speed packet controller 1041-1 is configured to select a communication interface to be used for data transmission/reception according to the control of the first processor 1020-1, and is configured to perform switching control to operate a processor (e.g., 1042-1 or 1043-1) corresponding to the selected communication interface. In this case, data or signals are configured to be output to the outside of the first satellite 110-1 through the communication interface processor (e.g., 1042-1 or 1043-1) and the communication interface (e.g., 1100-1 or 1200-1) selected by the high-speed packet controller 1041-1.

For example, when the high-speed packet controller 1041-1 selects the first communication interface 1100-1, e.g., a SpaceWire (SpW) interface, as the communication interface to be used for data transmission/reception, the data transmission path is configured to be switched to the first communication interface processor 1042-1 corresponding to the first communication interface 1100-1.

For example, when the high-speed packet controller 1041-1 selects the second communication interface 1200-1, e.g., a SpaceFibre (SpFi) interface, as the communication interface to be used for data transmission/reception, the data transmission path is configured to be switched to the second communication interface processor 1043-1 corresponding to the second communication interface 1200-1.

The first DTN unit 1050-1 is configured to temporarily store data in a storage device provided for DTN processing based on the SDN control signal transmitted from the first switching unit 1040-1, and configured to retransmit the data after recovery of the communication link.

The first DTN unit 1050-1 may include a DTN controller 1051-1 and a DTN storage device 1052-1.

The DTN controller 1051-1 is configured to determine whether to store data for DTN processing based on the SDN control signal. The DTN controller 1051-1 is configured to control the DTN storage device 1052-1 to transmit temporarily stored data based on whether the connection has been restored.

According to an embodiment, the SDN control information may include QoS identification information.

The DTN storage device 1052-1 is configured to store data for DTN processing under the control of the DTN controller 1051-1, and is configured to transmit the DTN processing result to the DTN controller 1051-1.

According to an embodiment, the DTN storage device 1052-1 is configured to transmit a DTN traffic signal including DTN traffic information to another satellite through the first switching unit 1040-1 and a communication interface 1100-1 or 1200-1.

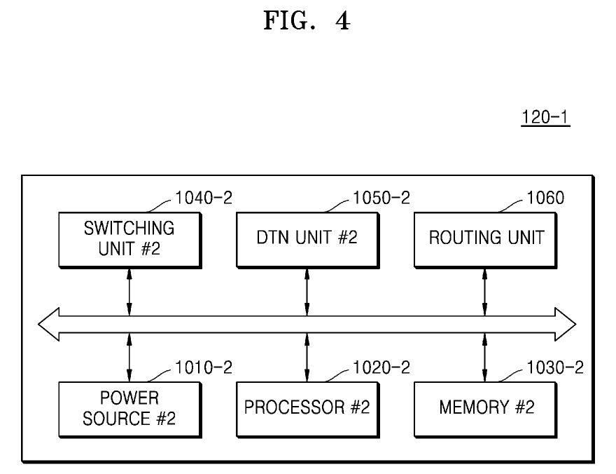

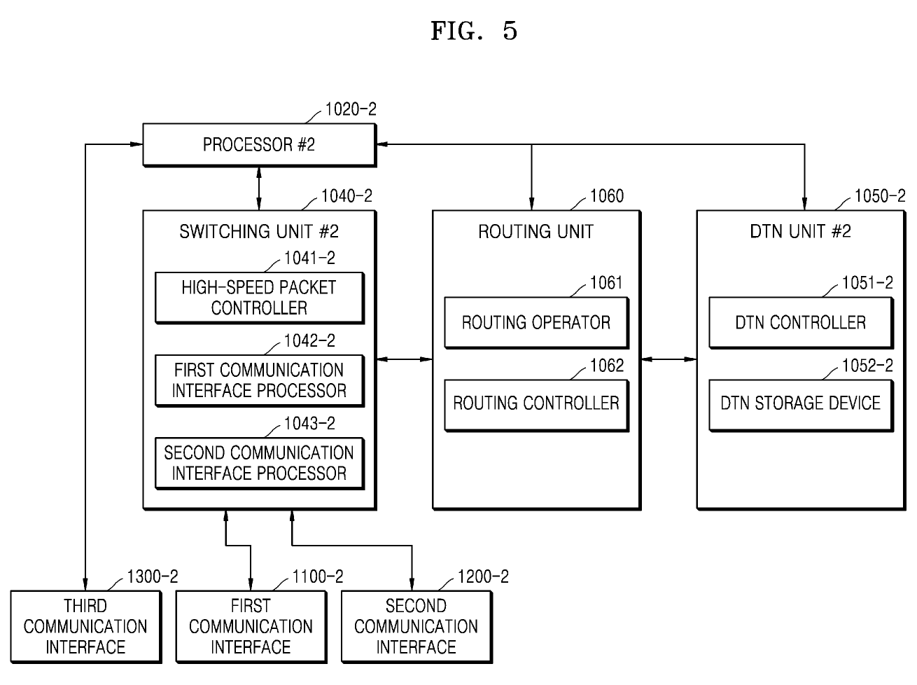

FIG. 4 is a block diagram of a second satellite shown in FIG. 1 according to an embodiment. FIG. 5 is a diagram for describing an operating method of the second satellite shown in FIG. 4.

FIG. 4 exemplarily illustrates a configuration of one second satellite 120-1 among the plurality of second satellites 120-1 to 120-3, but the remaining second satellites 120-2 to 120-3 may also be configured with substantially the same components and configured to perform substantially the same operations.

Referring to FIGS. 1 and 4, the second satellite 120-1 is configured to be responsible for a control area within the multi-orbit satellite system 10.

The second satellite 120-1 may include a second power source 1010-2, a second processor 1020-2, a second memory 1030-2, a second switching unit 1040-2, and a second DTN unit 1050-2.

The second power source 1010-2 is configured to stably supply power to each component within the second satellite 120-1.

According to an embodiment, the second power source 1010-2 may further include an energy harvesting device (e.g., a solar cell module) for stably securing energy in a space environment, a battery, and a Power Distribution Unit (PDU).

The second processor 1020-2 is a central processing unit for system control of the second satellite 120-1, and is configured to perform various data processing required in each configuration within the second satellite 110-2.

The second memory 1030-2 is configured to store programs necessary for the operation of the second processor 1020-2, data used in the computation processing of the second processor 1020-2, and data generated according to the computation processing result of the second processor 1020-2.

The second switching unit 1040-2 is configured to control the operation switching of configurations for data processing based on a plurality of communication interfaces.

The second DTN unit 1050-2 is configured to perform stable data communication by temporarily storing and then transmitting data even when a delay occurs in communication of the second satellite 120-1 or communication disconnection is expected.

The routing unit 1060 is configured to generate an SDN control signal for switching a communication interface within the first satellite (e.g., 110-1) based on a task distribution message including QoS requirement information transmitted from the first satellite (e.g., 110-1). The routing unit 1060 is configured to transmit the generated SDN control signal to the first satellite (e.g., 110-1).

Referring to FIG. 5, the second satellite 120-1 may include a plurality of communication interfaces 1100-2, 1200-2, and 1300-2.

The first communication interface 1100-2 and the second communication interface 1200-2 may be different types of communication interfaces constituting an Inter-Satellite Link (ISL).

According to an embodiment, each of the first communication interface 1100-2 and the second communication interface 1200-2 may be a SpaceFibre interface or a SpaceWire interface.

The third communication interface 1300-2 is an interface utilized for internal communication of the second satellite 120-1, and may be utilized for transmitting or receiving data(e.g., Telemetry (TM)) for payload status monitoring, or transmitting or receiving control signals (Telecommand (TC)) within the second satellite 120-1.

According to an embodiment, the third communication interface 1300-2 may be a Controller Area Network (CAN) interface.

The second processor 1020-2 is configured to transmit and receive data(e.g.,Telemetry (TM)) related to payload status monitoring within the second satellite 120-1 or control signals(e.g., Telecommand (TC)) through the third communication interface 1300-2.

The second processor 1020-2 is a central processing unit for system control of the second satellite 120-1, and is configured to perform various data processing required in each configuration within the second satellite 110-2.

The second switching unit 1040-2 may include a high-speed packet controller 1041-2, a first communication interface processor 1042-2, and a second communication interface processor 1043-2.

The high-speed packet controller 1041-2 is configured to select a communication interface to be used for data transmission/reception according to the control of the second processor 1020-2, and is configured to output data processed through a processor (e.g., 1042-2 or 1043-2) corresponding to the selected communication interface to the outside of the second satellite 120-1.

For example, when the high-speed packet controller 1041-2 selects the first communication interface 1100-2, e.g., a SpaceWire (SpW) interface, as the communication interface to be used for data transmission/reception, the data transmission path is configured to be switched to pass through the first communication interface processor 1042-2 corresponding to the first communication interface 1100-2.

For example, when the high-speed packet controller 1041-2 selects the second communication interface 1200-2, e.g., a SpaceFibre (SpFi) interface, as the communication interface to be used for data transmission/reception, the data transmission path is configured to be switched to pass through the second communication interface processor 1043-2 corresponding to the second communication interface 1200-2.

The high-speed packet controller 1041-2 is configured to select a communication interface to be used for data transmission/reception in the second satellite 120-1 based on the SDN control signal generated by the routing unit 1060, and is configured to switch to use a processor (e.g., 1042-2 or 1043-2) corresponding to the selected communication interface.

The routing unit 1060 may include a routing operator 1061 and a routing controller 1062.

The routing operator 1061 is configured to perform optimal path computation and communication interface selection for processing the task based on the task distribution request message transmitted from the first satellite 110-1 and status information (e.g., network collection information) of satellites included in the satellite group managed by the second satellite 120-1.

According to an embodiment, the status information of the satellites may include at least one of link status (e.g., delay time, data loss rate, link stability, bandwidth, etc.), power status (e.g., remaining battery capacity, power consumption, etc.), computation resources (e.g., processor utilization, processing capability), interface status (e.g., port utilization, interface activation status), and anomaly status (e.g., hardware error or software error, sensor anomaly, etc.).

The routing controller 1062 is configured to control routing paths of satellites included in the satellite group managed by the second satellite 120-1 and generate an SDN control signal for selecting (or switching) communication interfaces, based on the computation result of the routing operator 1061.

The second satellite 120-1 is configured to receive a task distribution request message including Quality of Service (QoS) requirement information from a first satellite (e.g., 110-1) corresponding to a lower node on a network topology defined in a Software Defined Network (SDN). In this case, the second processor 1020-2 of the second satellite 120-1 is configured to generate an SDN control signal corresponding to the received task distribution request message, and is configured to transmit the generated SDN control signal to the first satellite (e.g., 110-1).

According to an embodiment, the second satellite (e.g., 120-1) is configured to transmit the generated SDN control signal to the first satellite (e.g., 110-1) through the first communication interface processor 1042-2 of the second switching unit 1040-2 and the first communication interface 1100-2.

According to another embodiment, the second satellite (e.g., 120-1) is configured to transmit the generated SDN control signal to the first satellite (e.g., 110-1) through the second communication interface processor 1043-2 of the second switching unit 1040-2 and the second communication interface 1200-2.

According to an embodiment, the Software Defined Network is configured to define a data transmission path or a control signal transmission path between the plurality of satellites 110-1 to 110-9, 120-1 to 120-3, and 130 included in the multi-orbit satellite system 10.

According to an embodiment, the QoS requirement information may include information on a required delay tolerance time, reliability, and priority of a task.

According to an embodiment, the information on the priority of the task may include information for identifying a general service or an important service.

Referring to FIGS. 3 and 5, the first satellite (e.g., 110-1) is configured to transmit a task distribution request message to the second satellite (e.g., 120-1) corresponding to an upper node on a network topology defined in a Software Defined Network (SDN). The second satellite (e.g., 120-1) is configured to generate an SDN control signal based on the task distribution request message transmitted from the first satellite (e.g., 110-1) and configured to transmit the generated SDN control signal to the first satellite (e.g., 110-1). The first satellite (e.g., 110-1) is configured to set an internal communication path or switch a communication interface based on the SDN control signal transmitted from the second satellite (e.g., 120-1).

The second DTN unit 1050-2 is configured to temporarily store data in a storage device provided for DTN processing based on SDN control information included in the SDN control signal transmitted from the second switching unit 1040-2, and is configured to retransmit the data after recovery of the communication link.

The second DTN unit 1050-2 may include a DTN controller 1051-2 and a DTN storage device 1052-2.

The DTN controller 1051-2 is configured to determine whether to store data for DTN processing based on the SDN control signal. The DTN controller 1051-2 is configured to control the DTN storage device 1052-2 to transmit temporarily stored data based on whether the connection has been restored.

According to an embodiment, the SDN control information may include QoS identification information.

The DTN storage device 1052-2 is configured to store data for DTN processing under the control of the DTN controller 1051-2, and is configured to transmit the DTN processing result to the DTN controller 1051-2.

FIGS. 4 and 5 illustrate a case where the second satellite (e.g., 120-1) performs a function of a control area for the first satellite (e.g., 110-1), but according to an embodiment, the third satellite (e.g., 130) may perform a function of a control area for the first satellite (e.g., 110-1). In this case, the third satellite (e.g., 130) may include substantially the same configuration as the second satellite (e.g., 120-1), and may generate an SDN control signal corresponding to the task distribution request message of the first satellite (e.g., 110-1) in substantially the same manner as the second satellite (e.g., 120-1). The SDN control signal generated by the third satellite (e.g., 130) is configured to be transmitted to the first satellite (e.g., 110-1) through the second satellite (e.g., 120-1) that manages the managed satellite group to which the first satellite (e.g., 110-1) belongs.

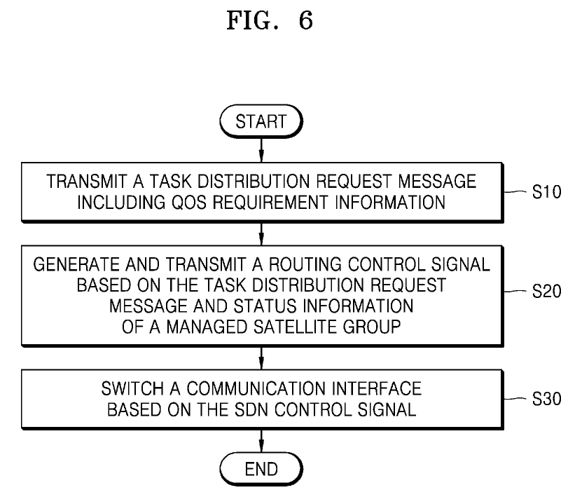

FIG. 6 is a flowchart of an operating method of the multi-orbit satellite system according to an embodiment of the present invention.

Referring to FIGS. 1-6, a satellite (e.g., 110-1) of the multi-orbit satellite system 10 according to an embodiment of the present invention is configured to transmit a task distribution request message including QoS requirement information to a satellite (e.g., 120-1 or 130) corresponding to an upper node on a network topology defined in the SDN (S10).

According to an embodiment, the satellite corresponding to the upper node on the network topology of the first satellite (e.g., 110-1) may be a second satellite (e.g., 120-1) directly corresponding to the upper node, or may be a third satellite (e.g., 130) indirectly corresponding to the upper node via another satellite.

A satellite (e.g., 120-1 or 130) that has received the task distribution request message transmitted in step S10 is configured to generate an SDN control signal based on the received task distribution request message and status information of a managed satellite group, and is configured to transmit the generated SDN control signal to the satellite (e.g., 110-1) that transmitted the task distribution request message (S20).

According to an embodiment, the managed satellite group may be defined by the Software Defined Network.

According to an embodiment, the SDN control signal may include various control information such as routing path control, interface switching, traffic priority setting, and transmission schedule control within the multi-orbit satellite system 10.

A satellite (e.g., 110-1) that has received the SDN control signal transmitted in step S20 is configured to switch a communication interface based on the received SDN control signal (S30).

According to an embodiment, the communication interface to be switched may be a SpaceFibre interface or a SpaceWire interface.

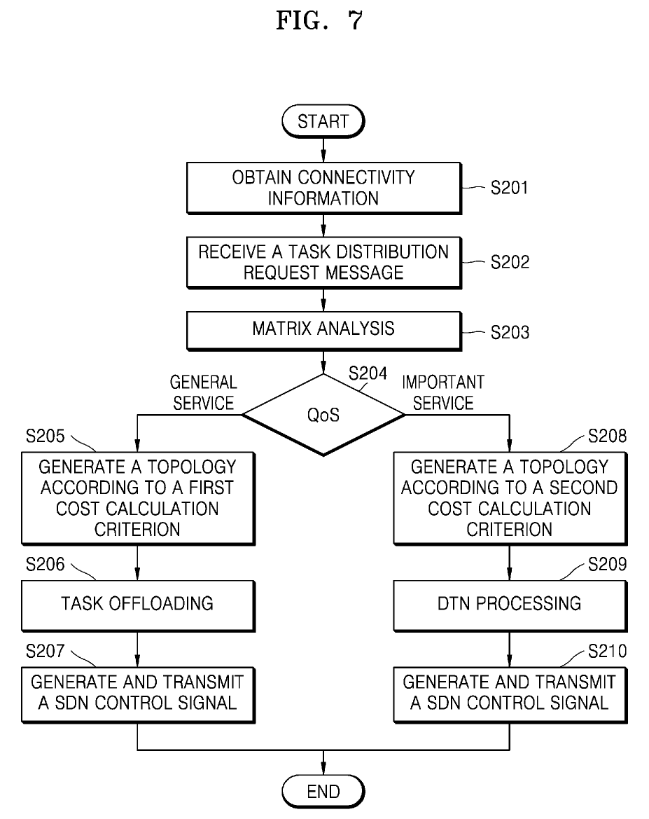

FIG. 7 is a flowchart showing an example of detailed steps constituting a process of generating an SDN control signal shown in FIG. 6.

Referring to FIGS. 6 and 7, FIG. 7 illustrates an example of detailed steps for generating an SDN control signal shown in FIG. 6.

A satellite (e.g., 120-1 or 130) responsible for the function of the control area is configured to obtain connectivity information on the network topology defined in the SDN (S201).

A satellite (e.g., 120-1 or 130) responsible for the function of the control area is configured to receive a task distribution request message including QoS requirement information from a satellite (e.g., 110-1) corresponding to a lower node on the network topology defined in the SDN (S202).

A satellite (e.g., 120-1 or 130) responsible for the function of the control area is configured to perform matrix analysis on the connectivity information obtained in step S201 (S203).

According to an embodiment, the matrix analysis may include an analysis that models the link status of the network topology defined in the SDN into a matrix.

A satellite (e.g., 120-1 or 130) responsible for the function of the control area is configured to perform analysis on the QoS requirement information included in the task distribution request message received in step S202 (S204).

As a result of the analysis in step S204, if it is a task distribution request message for a general service, a satellite (e.g., 120-1 or 130) responsible for the function of the control area is configured to generate a topology according to a first cost calculation criterion (S205).

According to an embodiment, the first cost calculation criterion may correspond to a cost calculation criterion for a maximum improvement of a system performance of a managed satellite group including transmission area satellites (e.g., 110-1 to 110-9). For example, an optimal path may be calculated based on available computing resources, energy consumption, and the like.

According to an embodiment, the optimal path may be calculated using a Dijkstra algorithm.

In this case, a satellite (e.g., 120-1 or 130) responsible for the function of the control area is configured to perform a task offloading operation based on the topology according to the first cost calculation criterion generated in step S204 (S206), and is configured to transmit an SDN control signal generated according to the task offloading operation to related satellites (S207).

As a result of the analysis in step S204, if it is a task distribution request message for an important service, a satellite (e.g., 120-1 or 130) responsible for the function of the control area is configured to generate a topology according to a second cost calculation criterion (S208).

According to an embodiment, the second cost calculation criterion may be a calculation criterion based on a required delay tolerance time and a required reliability included in the QoS requirement information included in the task distribution request message received in step S202.

According to an embodiment, a satellite (e.g., 120-1 or 130) responsible for the function of the control area is configured to preferentially calculate a path that satisfies the delay tolerance time and required reliability included in the QoS requirement information in step S207.

According to another embodiment, if there are a plurality of paths that satisfy the delay tolerance time and required reliability included in the QoS requirement information in step S207, a satellite (e.g., 120-1 or 130) responsible for the function of the control area is configured to additionally apply a cost calculation criterion for a maximum improvement of a system performance of the managed satellite group among the plurality of paths to calculate an optimal path. In this case, the optimal path may be calculated using a Dijkstra algorithm.

A satellite (e.g., 120-1 or 130) responsible for the function of the control area is configured to determine whether DTN processing is necessary to satisfy the QoS requirement information, and if DTN processing is required, is configured to include a control signal for DTN processing in the SDN signal (S209).

A satellite (e.g., 120-1 or 130) responsible for the function of the control area is configured to generate an SDN control signal including routing information according to the topology based on the second cost calculation criterion generated in step S207 and control information regarding DTN processing, and is configured to transmit the generated SDN control signal to related satellites (S210).

In addition, it will be apparent to one of ordinary skill in the art that various changes and modifications are possible within a range that does not deviate from the basic principles of the present disclosure.

What is claimed is:

1. A multi-orbit satellite system including a plurality of satellites operating in different orbits and using a Software-Defined Network (SDN) control technology, the multi-orbit satellite system comprising:
a first satellite for transmitting a task distribution request message including Quality of Service (QoS) requirement information to an upper node on a network topology defined in the Software-Defined Network; and
a second satellite for constituting the upper node of the first satellite in the network topology, receiving the task distribution request message, generating an SDN control signal based on the received task distribution request message and status information of a managed satellite group, and transmitting the generated SDN control signal to the first satellite,
wherein the first satellite switches a communication interface of the first satellite based on the SDN control signal.

2. The multi-orbit satellite system of claim 1, wherein the first satellite is a Low Earth Orbit (LEO) satellite, and the second satellite is a Medium Earth Orbit (MEO) satellite or a Geostationary Earth Orbit (GEO) satellite.

3. The multi-orbit satellite system of claim 1, wherein the Software-Defined Network is configured to define a data transmission path or a control signal transmission path between the plurality of satellites included in the multi-orbit satellite system.

4. The multi-orbit satellite system of claim 1, wherein at least a portion of the network topology defined by the Software-Defined Network is controlled by the second satellite.

5. The multi-orbit satellite system of claim 1, wherein the QoS requirement information includes information on a required delay tolerance time, reliability, and priority of a task.

6. The multi-orbit satellite system of claim 5, wherein the information on the priority of the task includes information for identifying a general service or an important service.

7. The multi-orbit satellite system of claim 1, wherein the first satellite includes :
a first power source;
a first processor;
a first switching unit for switching the communication interface; and
a first Delay Tolerant Network (DTN) processing unit for storing at least a portion of data transmitted and received for data loss protection.

8. The multi-orbit satellite system of claim 7, wherein the first satellite is configured to not directly perform an operation required for generating the SDN control signal, and is configured to switch the communication interface of the first satellite through the first switching unit based on the SDN control signal received from the second satellite.

9. The multi-orbit satellite system of claim 8, wherein the first switching unit of the first satellite switches the communication interface of the first satellite between a SpaceFibre interface and a SpaceWire interface.

10. The multi-orbit satellite system of claim 1, wherein the status information of the managed satellite group includes link status, power status, computation resource status, communication interface status, and anomaly status of each of the satellites included in the satellite group managed by the second satellite.

11. The multi-orbit satellite system of claim 1, wherein the second satellite includes :
a second power source;
a second processor;
a second switching unit for switching a communication interface;
a second DTN processing unit for storing at least a portion of data transmitted and received for data loss protection; and
a routing unit configured to generate the SDN control signal.

12. The multi-orbit satellite system of claim 11, wherein the routing unit is configured to reset a network topology of the satellites included in the managed satellite group.

13. The multi-orbit satellite system of claim 11, wherein the routing unit is configured to generate the SDN control signal using a Dijkstra algorithm.

14. The multi-orbit satellite system of claim 1, wherein the first satellite and the second satellite are connected via an Inter-Satellite Link (ISL).

15. The multi-orbit satellite system of claim 1, wherein the second satellite is configured to matrix the multi-orbit satellite system based on the status information of the managed satellite group and the network topology, and is configured to generate the SDN control signal by applying a Dijkstra algorithm to the matrixed multi-orbit satellite system.

16. The multi-orbit satellite system of claim 15, wherein the second satellite is configured to generate the SDN control signal by applying different cost calculation criteria based on whether a corresponding task is an important service or a general service, according to information regarding the priority of the task included in the QoS requirement information.

17. The multi-orbit satellite system of claim 16, wherein the second satellite is configured to generate the SDN control signal according to a cost calculation criterion for a maximum improvement of a system performance of the managed satellite group when the corresponding task is the general service, and is configured to generate the SDN control signal according to a cost calculation criterion for satisfying a required delay tolerance time and a required reliability included in the QoS requirement information when the corresponding task is the important service.

18. A method of operating a multi-orbit satellite system including a plurality of satellites operating in different orbits and using a Software-Defined Network (SDN) control technology, the method comprising:
transmitting, by a first satellite, a task distribution request message including Quality of Service (QoS) requirement information to an upper node on a network topology defined in the Software-Defined Network;
generating, by the second satellite, an SDN control signal based on the task distribution request message and status information of a managed satellite group, and transmitting the generated SDN control signal to the first satellite; and
switching, by the first satellite, a communication interface of the first satellite based on the SDN control signal.
